(19) United States
(12) Patent Application Publication
(10) Pub. No.: US 2014/0370458 A1
(43) Pub. Date: Dec. 18, 2014

(54) STRUCTURE DESIGN OF CERAMIC DRILL FOR DENTAL IMPLANT SURGERY

(71) Applicant: Ming-Tzung Lee, Taipei City (TW)

(72) Inventors: Ming-Dih JENG, Taipei City (TW); Ting-Hsun YANG, Taipei City (TW); Ming-Tzung LEE, Taipei City (TW)

(73) Assignee: Ming-Tzung Lee, Taipei City (TW)

(21) Appl. No.: 14/259,000

(22) Filed: Apr. 22, 2014

(30) Foreign Application Priority Data
Jun. 18, 2013 (TW) 102211365

(51) Int. Cl. A61C 3/02; A61C 8/00

(52) U.S. Cl. CPC A61C 3/02; A61C 8/0089
USPC 433/166

(57) ABSTRACT

A drilling structure is disclosed. The disclosed drilling structure may include a drill head. A bottom end of the drill head may be provided with a connecting portion for connecting an adjoining portion of the dental implant hand piece, and a top end of the drill head may be implemented in terms of a multi-facet convex polyhedron cone head. The multi-facet convex polyhedron cone head is with at least three facet. The connecting portion may require a metal adaptor to be coupled to the adjoining portion of the dental implant hand piece

### BACKGROUND

1. Technical Field

The present disclosure relates to a ceramic drilling structure design used with hand piece in dental implant surgery, particularly the functional head with convex polyhedron cone to work more efficiently.

2. Description of Related Art

Dental implant is an artificial tooth transplant in which artificial tooth roots made of titanium or similar material that is not subject to transplant rejection would be placed in the alveolar bone to function as a missing tooth root on which an artificial tooth is mounted.

In the implant surgery, an implant that could be fused in the alveolar bone is insert before an abutment supportive of the artificial tooth is placed on the implant. The artificial tooth, which may be referred to as a crown, is thereafter put on the abutment. Before the implant could be fused with the bone in the alveolar bone, Osseo-integration needs to be administered to the bone of the alveolar bone by having a small hole that is smaller than the implant in diameter drilled on the bone allowing for the implant to be tightly fused in the alveolar bone.

The dental implant surgery procedure generally utilizes a drill powered by a hand piece to penetrate alveolar bone. Since the procedure performed by dentists may vary, the usage of the drilling structure and the sequence of the same may be different from one to another. Drilling heads of the drilling structure used in the procedure may be different in size and even shape. Generally, the position of the hole would need to be specified and penetrated before any hole drilling could be performed. The hole drilling is performed by the suitable designed drilling heads in accordance with the size of the implant before any reaming and trimming could be completed. The drilling structures used in each of the above stages such as hole penetration and drillings are different, which undoubtedly would complicate the procedure and significantly extend the time required for the procedure to conclude. Though the drilling structures are made of metals and coated with varies surface treatment material on the surface thereof, to ensure no post-procedure complications high-temperature sterilization/disinfection needs to be performed on the drilling structures or more specifically the drilling heads. However, the drilling structures or the drilling heads could find the coated material peeled off or degraded after experiencing the long-term high-temperature sterilization/disinfection. Consequently, the rust may be accumulated on the surface of the drilling structures/drilling heads, which may further cause more severe symptoms on the part of patients such as Cellulites.

Therefore, if the drilling heads could be designed to be of multiple purposes (i.e., suitable for different tasks such as drilling and trimming) the time for the procedure to be wrapped up could be effectively shortened. Meanwhile, if the drilling heads could be less susceptible to the accumulation of rust associated with the sterilization or disinfection the drilling structures/drilling heads may enjoy the extended shelf time.

### SUMMARY OF THE DISCLOSURE

The present disclosure provides a drilling structure used in a dental implant hand piece. The disclosed drilling structure may be superior in hardness and convex polyhedron cone. That drilling structure may be convex polyhedron cone headed could save lot of time to have the dental implant procedure more efficient.

The disclosed drilling structure may be made of ceramic such as: zirconia or alumina, which could minimize the occurrence of the drilling structure being rusty.

The disclosed drilling structure may include a drill head. A bottom end of the drill head may be provided with a connecting portion for connecting an adjoining portion of the dental implant hand piece, and a top end of the drill head may be implemented in terms of a multi-facet convex polyhedron cone head. The multi-facet vertebral head is with at least three facet.

More specifically, in one implementation the diameter of the drill head gradually increases from the bottom end to the top end thereof and the bottom end is smaller than the top end of the drill head in diameter.

More specifically, in another implementation the bottom end and the top end of the drill head is substantially the same in diameter.

More specifically, the multi-facet convex polyhedron cone head is with a pointed top.

In another implementation, the multi-facet convex polyhedron cone head is with a flat top or an arced top.

More specifically, the drill head is made of ceramic such as: zirconia or alumina.

Another embodiment of the present disclosure may include a drill head with a bottom end of the drill head providing a connecting portion coupling to a first end of a metal adaptor, a second end of the metal adaptor coupled to an adjoining portion of the dental implant hand piece hand piece, and a top end of the drill head main body implemented in terms of a multi-facet convex polyhedron cone head. The multi-facet convex polyhedron cone head is with at least three vertebral surfaces.

More specifically, the connecting portion is provided with two polygonal connecting surfaces in between a cavity is formed, and the first end of the metal adaptor connects to the cavity and the polygonal connecting surfaces.

More specifically, the diameter of the drill head gradually increases from the bottom end to the top end thereof and the bottom end is smaller than the top end of the drill head in diameter.

More specifically, the bottom end and the top end of the drill head is substantially the same in diameter.

In one implementation, the multi-facet convex polyhedron cone head is with a pointed top.

In another implementation, the multi-facet convex polyhedron cone is with a flat top or an arced top.

More specifically, the drill head main body is made of ceramic such as: zirconia or alumina.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

The drawings included herein provide further understanding of the present disclosure. A brief introduction of the drawings is as follows:

FIG. 1 shows a first structural diagram of a drilling structure according to one embodiment of the present disclosure;

FIG. 2 shows a second structural diagram of a drilling structure according to one embodiment of the present disclosure;

FIG. 3 shows a third structural diagram of a drilling structure according to one embodiment of the present disclosure;

FIG. 4 shows a fourth structural diagram of a drilling structure according to one embodiment of the present disclosure;

FIG. 5 shows a structural diagram of a drilling structure connecting to a dental implant hand piece according to one embodiment of the present disclosure;

FIG. 6 shows a first structural diagram of a drilling structure according to another embodiment of the present disclosure;

FIG. 7 shows a second structural diagram of a drilling structure according to another embodiment of the present disclosure;

FIG. 8 shows a third structural diagram of a drilling structure according to another embodiment of the present disclosure;

FIG. 9 shows a fourth structural diagram of a drilling structure according to another embodiment of the present disclosure; and

FIG. 10 shows a structural diagram of a drilling structure connecting to a dental implant hand piece according to another embodiment of the present disclosure.

### DESCRIPTION OF THE EXEMPLARY EMBODIMENTS

The aforementioned and other technical contents, features, and efficacies will be shown in the following detail descriptions of a preferred embodiment corresponding with the reference Figures.

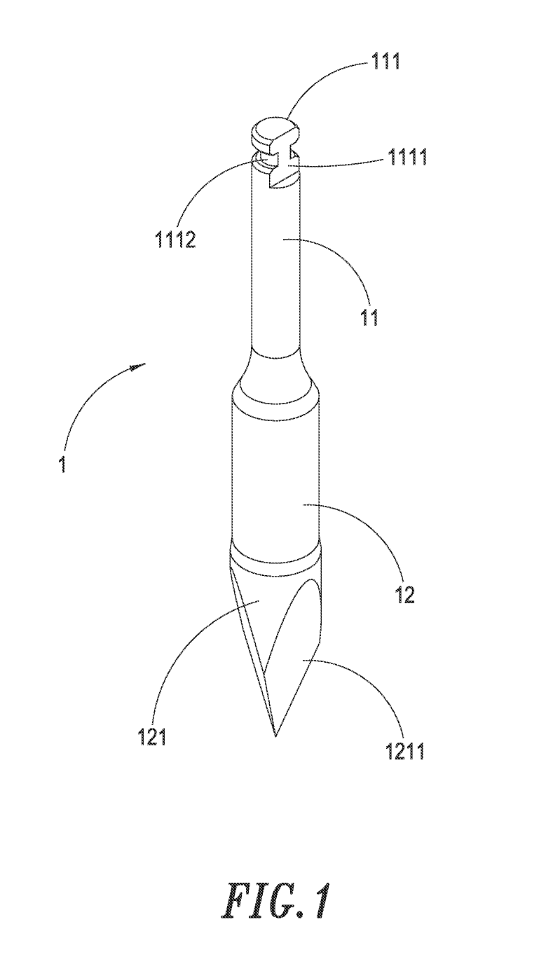

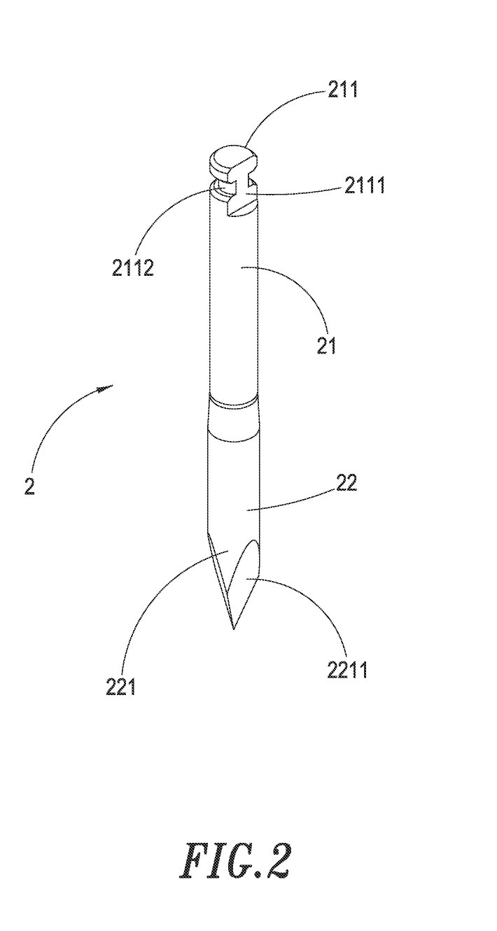

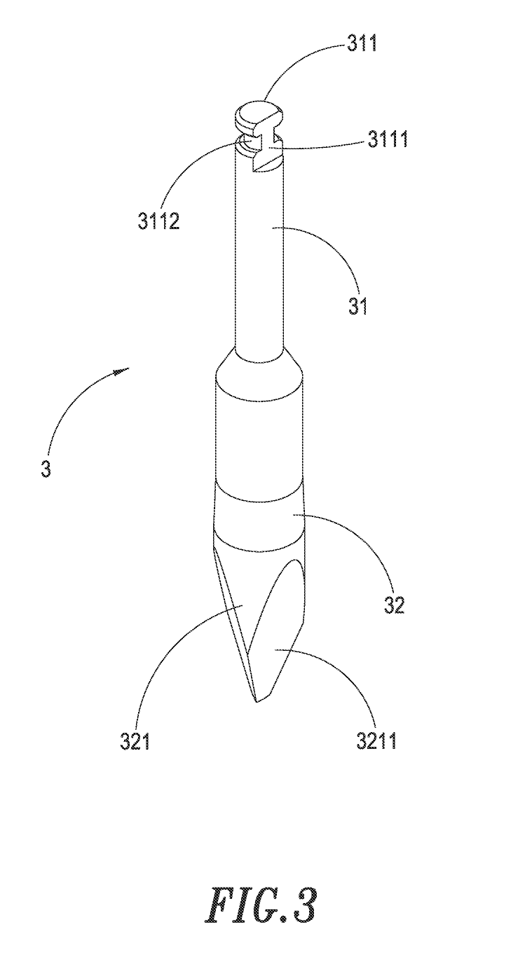

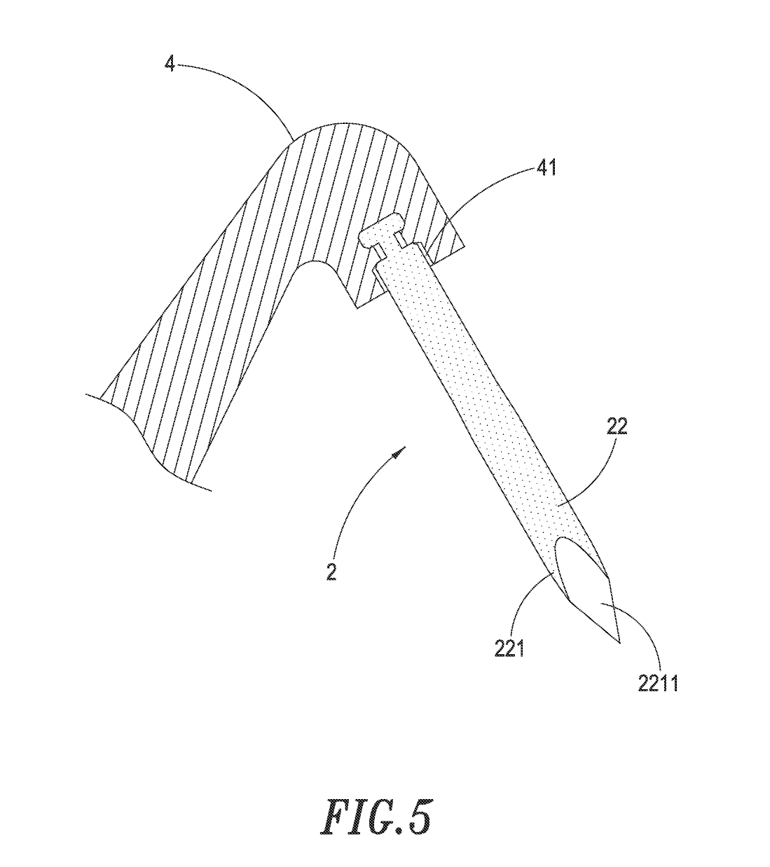

Please see FIGS. 1-4 illustrating structural diagrams of a first drilling structure used in a dental implant hand piece according to one embodiment of the present disclosure. As shown in the above-mentioned figures, the disclosed drilling structures may include a drill head 1, 2, and 3. The drill head 1-3 may include one connecting portion 111, 211, and 311, respectively. Each of the connecting portions 111, 211, and 311 may be provided with its own groove surface such as 1111, 2111, or 3111 and its own cavity such as 1112, 2112, or 3112. As shown in FIG. 5, the connecting portion 111, 211, or 311 may be used to be coupled to an adjoining portion 41 of a dental implant hand piece 4. A top end of the drill head 12, 22, or 32 may be implemented in terms of a multi-facet vertebral head 121, 221, or 321. The multi-facet vertebral head 121, 221, or 321 may have at least three vertebral surfaces 1211, 2211, 3211. Traditionally, the drill head is of a spiral column variety in its drill head, which remains desired in effective operational area ratio. In short, the adoption of the spiral column in the drill head generally does not effectively utilize its operational capability, not to mention the potential of the consequential spike in temperature at the area in contact with the drill head main body as the result of the increased friction between the spiral column-type drill head and the area where the drill head would operate. Compared with the traditional drill head with the circular drill head, the multi-facet vertebral head may result in less vibration on the part of the drill head. And the less amount of the vibration may ensure the more precise positioning of the drill head structure when in use.

The drill head 1, 2, and 3 may be made of fine ceramics such as zirconia or alumina, and will form a mirror finish on the surface, which may prevent the drill head 1-3 and the mirror structure from being foreign material cohered.

The drill head main body 1-3 may be of multiple purposes. As for the structure shown in FIGS. 1-4, bottom ends 11 and 31 of the drill head main bodies 1 and 3 are smaller than top ends 12 and 32 of the same drill head 1 and 3 in diameter. Additionally, the multi-facet convex polyhedron cone heads 121 and 221 may be having pointed tops while the multi-facet convex polyhedron cone head 321 may be having a flat top. As such, the drill head 1 and 2 may be used in penetrating, positioning, drilling, and reaming while the drill head 3 may be used in increasing the effective cutting length.

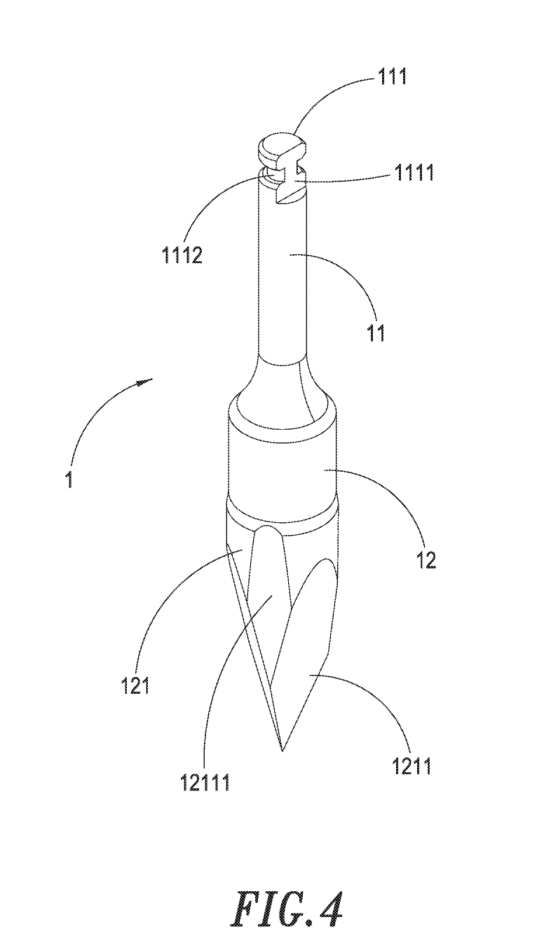

One difference that lies between FIGS. 1 and 4 is the vertebral surface 1211 forming a helical surface 12111 for reducing the heat generated because of the friction in the reaming process. Further, such design may help remove scalps at the time of being retracted from the implant.

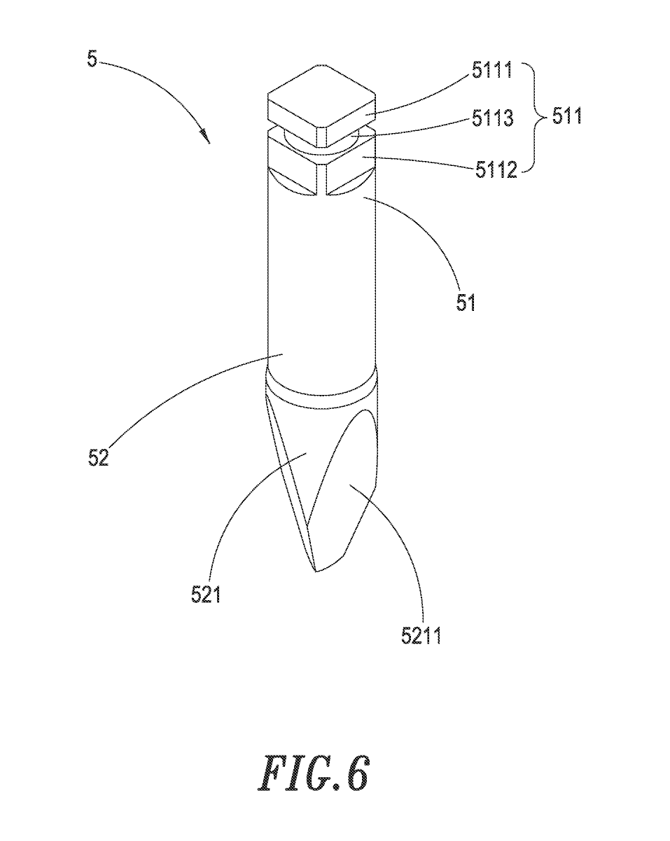

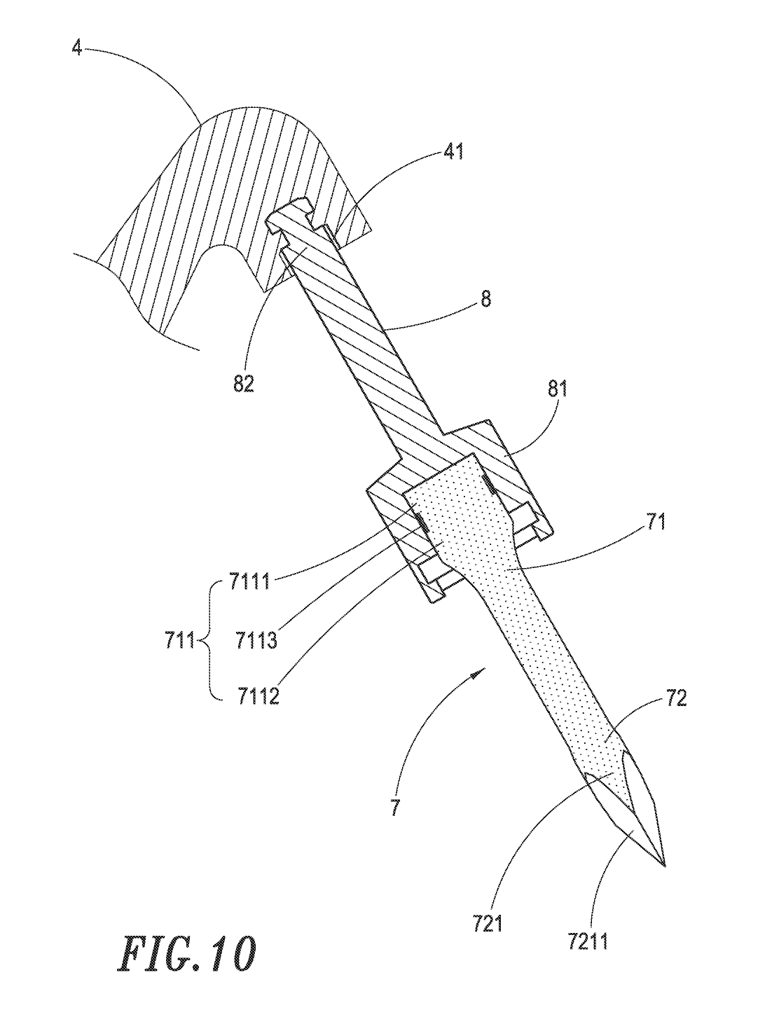

As the top end of the drill head main body 1, 2, or 3 is larger in diameter, the area could be drilled or reamed could become larger. Even if that is the case, such drill head 1, 2, or 3 may be subject to being cracked since the bottom end of the drill head 1, 2, or 3 could no longer provide the adequate support for the top end of the same drill head 1, 2, or 3. To prevent the above from taking space, embodiments in FIGS. 6-9 where bottom ends 51, 61, and 71 of drill head 5-7 and top ends 52, 62, and 72 of the same are substantially the same in diameter are proposed. With that arrangement, the potential crack in the drill head 5, 6, or 7 may be minimized. At the same time, the drill head 5-7 of the embodiments may need an intermediary metal adaptor 8 shown in FIG. 10 to be in connection with the dental implant hand piece 4. For coupling to the metal adaptor 8, the bottom ends 51, 61, and 71 may have connecting portions 511, 611, and 711 coupling a first end 81 of the metal adaptor 8. And a second end 82 of the metal adaptor 8 may be adapted to connect to the adjoining portion 41 of the dental implant hand piece 4. In one implementation, the top ends 52, 62, and 72 of the drill head 5-7 may be implemented in terms of multi-facet vertebral heads such as 521, 621, and 721. And each of the vertebral heads 521, 621, and 721 may have at least three vertebral surfaces such as 5211, 6211, and 7211.

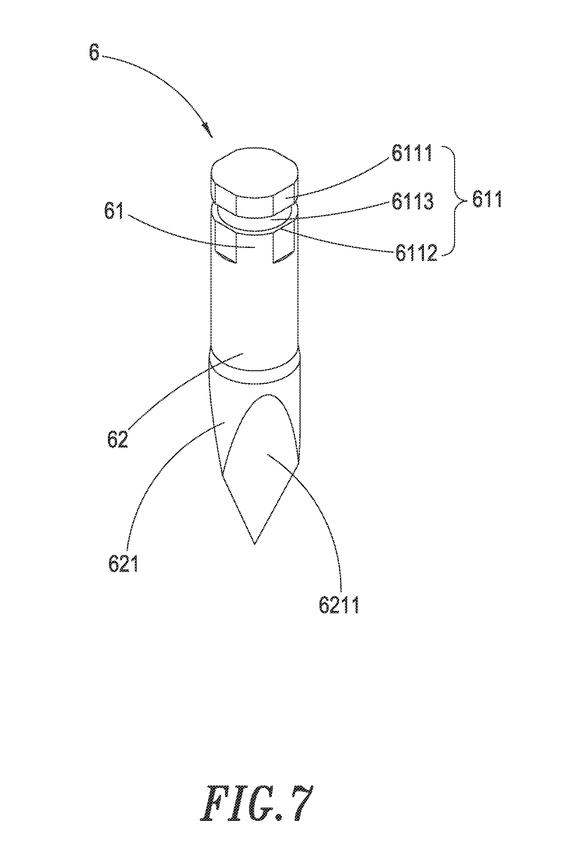

As illustrated in FIGS. 7-9, the connecting portions 511, 611, and 711 may be of a quadrangle. Thus, the first end 81 of the metal adaptor 8 may be formed in another quadrangle corresponding to and accommodating the connecting portions 511, 611, and 711. Since the shape of the connecting portions 511, 611, and 711 may vary (for example, the connecting portion 511 may be hexagon shaped), the first end 81 of the metal adaptor 8 may be shaped correspondingly for facilitating the connection between the connecting portions 511, 611, and 711 and the metal adaptor 8.

The connecting portions 511, 611, and 711 at the bottom ends 51, 61, and 71 of the of the drill head 5-7 are different from the connecting portions 111, 211, and 311. The connecting portion 511, 611, and 711 may be with polygonal surfaces 5111, 5112, 6111, 6112, 7111, and 7112. And cavities 5113, 6113, and 7113 may be formed between the polygonal surfaces 5111 and 5112, 6111 and 6112, and 7111 and 7112. Plus, the first end 81 of the metal adaptor 8 may be configured to be formed for robustly coupling the cavities 5113, 6113, and 7113 and the polygonal surfaces 5111, 5112, 6111, 6112, 7111, and 7112. Consequently, the connecting portions 511, 611, and 711 may be coupled within the first end 81 of the metal adaptor 8.

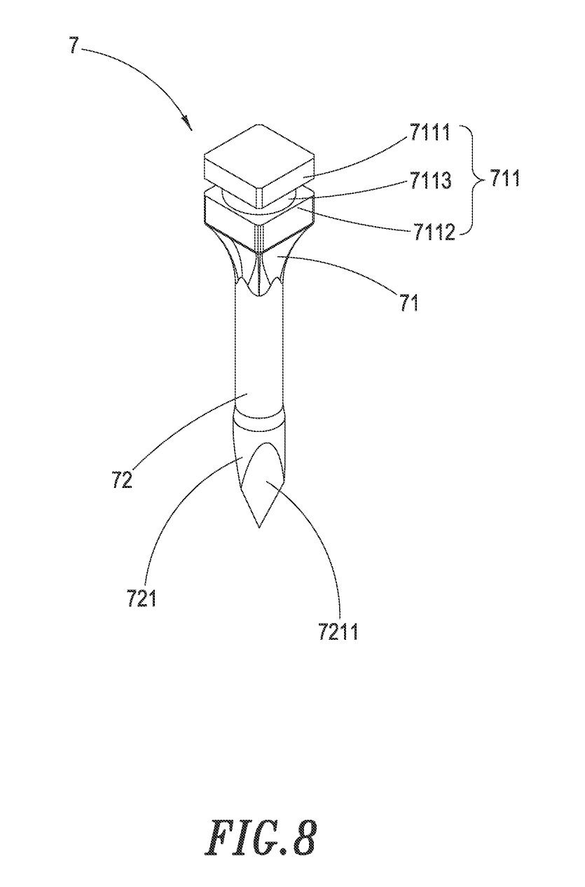

The drill head may be of multiple purposes. As shown in FIGS. 7-8, the diameter of the drill head 7 may increase from the bottom end 71 all the way to the top end 72. Meanwhile, the diameter of the bottom ends 51 and 61 of the drill head 5 and 6 may be substantially equal to the diameter at the top ends 52 and 62. The multi-facet convex polyhedron cone heads 621 and 721 may be with a pointed top though the multi-facet convex polyhedron cone head 521 may be with a flat top. As such, the drill head 6 and 7 may be used in penetrating, positioning, drilling, and reaming while the drill head 5 may be used in increasing the effective cutting length.

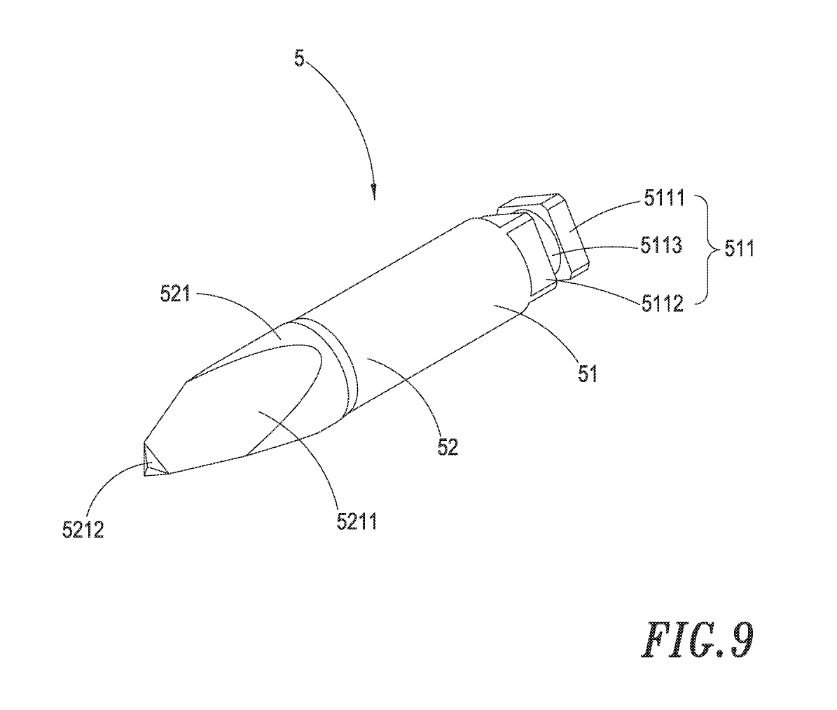

Further, as shown in FIG. 9, the multi-facet convex polyhedron cone head 521 may have a pointed surface 5212 formed at a top thereof. That multi-facet convex polyhedron cone head 521 may be suitable for multiple drilling-related tasks since the pointed surface 5212 may help in drilling a hole and trimming without stopping the downward drilling operation. Therefore, one single drill head could be sufficient in wrapping up the entire drilling process.

One major purpose of the cavities 5113, 6113, and 7113 between the two polygonal surfaces 5111 and 5112, 6111 and 6112, and 7111 and 7112 may help properly position the drill head 5-7 within the metal adaptor 8, though the polygonal surfaces 5111, 5112, 6111, 6112, 7111, and 7112 may serve that purpose without the cavities 5113, 6113, and 7113 formed.

When compared with other conventional techniques, the present disclosure may offer the following advantage: (1) the drill head main body of the disclosed drilling structure may be of multiple purposes, eliminating the need of additional drill head to be substituted in and out during the operation to shorten the length of the operation, and (2) the drill head is made of zirconia or alumina, which is superior in hardness, anti-corrosion, and high temperature resistance, and less likely to be rusty.

Some modifications of these examples, as well as other possibilities will, on reading or having read this description, or having comprehended these examples, will occur to those skilled in the art. Such modifications and variations are comprehended within this disclosure as described here and claimed below. The description above illustrates only a relative few specific embodiments and examples of the present disclosure. The present disclosure, indeed, does include various modifications and variations made to the structures and operations described herein, which still fall within the scope of the present disclosure as defined in the following claims.

What is claimed is:

1. A drilling structure used in dental implant surgery, composed a functional head and a connection port for hand piece. The functional head is a convex polyhedron cone with three facet at least.

2. The drilling structure according to claim 1, wherein the diameter of the drill head gradually increases from the bottom end to the top end thereof and the bottom end is smaller than the top end of the drill head in diameter.

3. The drilling structure according to claim 1, wherein the bottom end and the top end of the drill head is substantially the same in diameter.

4. The drilling structure according to claim 1, wherein the multi-facet convex polyhedron cone head is with a pointed top.

5. The drilling structure according to claim 1, wherein the multi-facet convex polyhedron cone head is with a flat top or an arced top.

6. The drilling structure according to claim 1, wherein the drill head is made of ceramic such as: zirconia or alumina

7. A drilling structured used in a dental implant hand piece, comprising: a drill functional head, a opposite bottom end of the drill head providing a connecting portion coupling to a first end of a metal adaptor, a second end of the metal adaptor coupled to an connection port of the dental implant hand piece, a top end of the drill head as a multi-facet convex polyhedron head, wherein the multi-facet convex polyhedron cone head is with at least three convex polyhedron cone surfaces.

8. The drilling structure according to claim 7, wherein the connecting port is a special design with two polygonal in between a holding part to fit the metal adaptor which is further connected to hand piece.

9. The drilling structure according to claim 7, diameter of the drill head gradually increases from the bottom end to the top end thereof and the bottom end is smaller than the top end of the drill head in diameter.

10. The drilling structure according to claim 7, wherein the bottom end and the top end of the drill head is substantially the same in diameter.

11. The drilling structure according to claim 7, wherein the multi-facet convex polyhedron cone head is with a pointed top.

12. The drilling structure according to claim 7, wherein the multi-facet convex polyhedron cone head is with a flat top or an arced top.

13. The drilling structure according to claim 7, wherein the drill is made of ceramic such as zirconia or alumina.
